(19) United States
(12) Patent Application Publication
(10) Pub. No.: US 2023/0045950 A1
(43) Pub. Date: Feb. 16, 2023

(54) COUNTERFACTUAL SELF-TRAINING

(71) Applicant: International Business Machines Corporation, Armonk, NY (US)

(72) Inventors: Ruijiang Gao, Austin, TX (US); Wei Sun, Tarrytown, NY (US); Max Biggs, Charlottesville, VA (US); Markus Ettl, Yorktown heights, NY (US); Youssef Drissi, Peekskill, NY (US)

(21) Appl. No.: 17/402,367

(22) Filed: Aug. 13, 2021

(51) Int. Cl. G06N 20/00

(52) U.S. Cl. CPC G06N 20/00

(57) ABSTRACT

A method of using a computing device to self-train a machine learning model with an incomplete dataset including original observational data. The method includes receiving a labeled training data, the labeled training data for training a machine learning model. Counterfactual unlabeled training data is received. One or more labels are predicted for the counterfactual unlabeled training data. The machine learning model is trained based upon the labeled training data, the counterfactual unlabeled training data, and the predicted one or more labels for the unlabeled training data. The machine learning model reduces bias in original observational data. An evaluation of the predicted one or more labels is received based on corresponding artificial intelligence explanations provided by an artificial intelligence explainability model.

### BACKGROUND

The field of embodiments of the present invention relates to fair comparison for parallel machine learning (ML) algorithms or models.

Unlike traditional supervised ML, in many settings only partial feedback is available. Outcomes for the chosen actions may only be observed, but not the counterfactual outcomes associated with other alternatives. Such settings encompass a wide variety of applications including pricing, online marketing and precision medicine. For example, in pricing, it is not observed what would occur if a different promotion was offered. In contrast to the gold standard of a randomized controlled trial, observational data are influenced by historical policy deployed in the system, which may over or under represent certain actions, yielding a biased data distribution. Failure to account for the bias introduced by historical policy often results in an algorithm which has high accuracy on the data it was trained on, but performs considerably worse under a different policy.

### SUMMARY

Embodiments relate to counterfactual learning with observational data using self-learning. One embodiment provides a method of using a computing device to self-train a machine learning model with an incomplete dataset including original observational data. The method includes receiving a labeled training data, the labeled training data for training a machine learning model. The method includes receiving a labeled training data, the labeled training data for training a machine learning model. Counterfactual unlabeled training data is received. One or more labels are predicted for the counterfactual unlabeled training data. The machine learning model is trained based upon the labeled training data, the counterfactual unlabeled training data, and the predicted one or more labels for the unlabeled training data. The machine learning model reduces bias in original observational data. An evaluation of the predicted one or more labels is received based on corresponding artificial intelligence explanations provided by an artificial intelligence explainability model.

One or more of the following features may be included. In some embodiments, the method may further include that the machine learning model simulates a randomized control trial.

In some embodiments, the method may further include that the simulated randomized control trial data mitigates the bias present in the original observational data due to historical policy.

In one or more embodiments, the method may further include that the machine learning model is applied to settings with discrete actions and discrete outcomes.

In one or more embodiments, the method may include that the machine learning model imputes labels on the counterfactual unlabeled training data.

In some embodiments, the method may further include that the machine learning model is iteratively updated on the imputed labels and factual data, and re-imputes labels until convergence. In one or more embodiments, an initial classifier is trained on the original observational data.

These and other features, aspects and advantages of the present embodiments will become understood with reference to the following description, appended claims and accompanying figures.

### BRIEF DESCRIPTION OF THE DRAWINGS

FIG. 1 illustrates a diagram of a process for augmentation of observational data and updating of a machine learning (ML) model by iterative training on both imputed counterfactual data and the factual data, according to one embodiment;

FIG. 2 illustrates a flow diagram for updating of an ML model by iterative training on both imputed counterfactual data and factual data, according to one embodiment;

FIG. 3 illustrates a counterfactual self-training (CST) algorithm for iteratively training an ML model including imputing pseudo-labels until convergence, according to one embodiment;

FIG. 4A illustrates a table showing Hamming loss on a synthetic dataset for a CST process, according to one embodiment;

FIG. 4B illustrates a table showing a multi-label soft-margin loss on synthetic datasets for a CST process, according to one embodiment;

FIG. 4C illustrates a table showing a total reward on a synthetic dataset for a CST process, according to one embodiment;

FIG. 5 illustrates average running time results for a for a CST process using three datasets, according to one embodiment;

FIG. 6 illustrates average running time results for synthetic datasets for a CST process, according to an embodiment;

FIG. 7A illustrates a graph for a CST process with a direct method on factual data alone, according to an embodiment;

FIG. 7B illustrates a graph showing results after a first imputation with a CST process, according to an embodiment;

FIG. 7C illustrates a graph showing results upon convergence with a CST process, according to an embodiment;

FIG. 8 shows a process for CST for reducing bias in observational data by simulating a randomized control trial, according to an embodiment;

FIG. 9 depicts a cloud computing environment, according to an embodiment;

FIG. 10 depicts a set of abstraction model layers, according to an embodiment;

FIG. 11 is a network architecture of a system for, according to an embodiment;

FIG. 12 shows a representative hardware environment that may be associated with the servers and/or clients of FIG. 9, according to an embodiment; and

FIG. 13 is a block diagram illustrating a distributed system for CST processing that reduces bias in observational data by simulating a randomized control trial, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to counterfactual learning with observational data using self-learning. One embodiment provides a method of using a computing device to self-train a machine learning model with an incomplete dataset including original observational data. The method includes receiving a labeled training data, the labeled training data for training a machine learning model. The method includes receiving a labeled training data, the labeled training data for training a machine learning model. Counterfactual unlabeled training data is received. One or more labels are predicted for the counterfactual unlabeled training data. The machine learning model is trained based upon the labeled training data, the counterfactual unlabeled training data, and the predicted one or more labels for the unlabeled training data. The machine learning model reduces bias in original observational data. An evaluation of the predicted one or more labels is received based on corresponding artificial intelligence explanations provided by an artificial intelligence explainability model.

One or more of the following features may be included. In some embodiments, the method may further include that the machine learning model simulates a randomized control trial.

In some embodiments, the method may further include that the simulated randomized control trial data mitigates the bias present in the original observational data due to historical policy.

In one or more embodiments, the method may further include that the machine learning model is applied to settings with discrete actions and discrete outcomes.

In one or more embodiments, the method may include that the machine learning model imputes labels on the counterfactual unlabeled training data.

In some embodiments, the method may further include that the machine learning model is iteratively updated on the imputed labels and factual data, and re-imputes labels until convergence. In one or more embodiments, an initial classifier is trained on the original observational data.

One or more embodiments relate to ML models or algorithms that employ one or more artificial intelligence (AI) models or algorithms. AI models may include a trained ML model (e.g., models, such as a neural network (NN), a convolutional NN(CNN), a recurrent NN (RNN), a Long short-term memory (LSTM) based NN, gate recurrent unit (GRU) based RNN, tree-based CNN, K-nearest neighbor (KNN) as a NN, a self-attention network (e.g., a NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

A naive but widely used approach is to learn an offline ML algorithm directly from observational data and use it for prediction—this is known as the “Direct Method.” The Direct Method functions without accounting for the selection bias introduced by historical policy results in estimators, which are also biased and unreliable. The Direct Method runs an online A/B test as a randomized trial that: requires carefully designed experiments and an interactive platform to support; can be very costly (in terms of processing and memory) by fielding a bad policy; the number of A/B tests is limited; and there is a relatively long turnaround time.

In one or more embodiments, the counterfactual inference problem is framed as a domain adaptation problem where the source domain is the factual data (i.e., observational data), while the target domain is a randomized trial on the same feature distribution. In one embodiment, a randomized trial is explicitly simulated by imputing pseudo-labels for the unobserved actions (i.e., the counterfactuals). The optimization process is performed by iteratively updating the pseudo-labels and with an ML model that is trained on both the factual and the counterfactual data. As this process works in a self-supervised fashion, it may be referred to it as Counterfactual Self-Training (CST) herein.

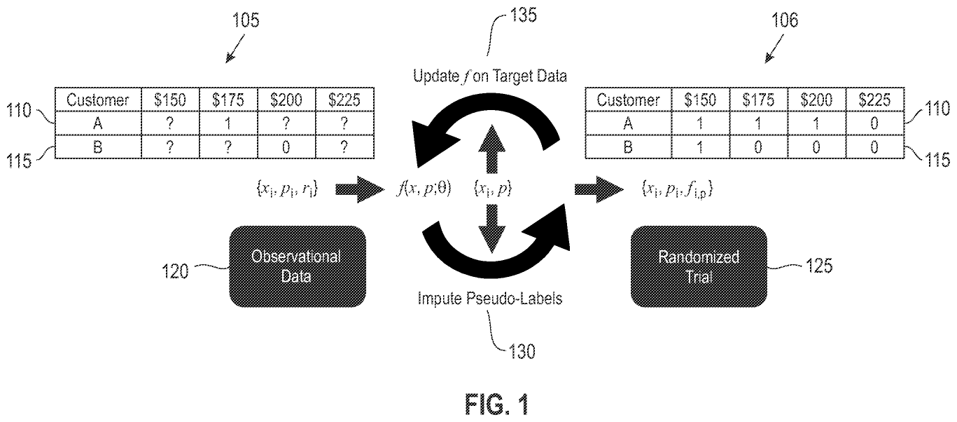

FIG. 1 illustrates a diagram of a process for augmentation of observational data 120 and updating of an ML model by iterative training on both imputed counterfactual data and the factual data, according to one embodiment. In one example embodiment, suppose there are two sales records (observational data 120) shown in table 105, i.e., Customer A 110 was offered $175 and upgraded (e.g., purchased goods or a service); Customer B 115 was offered $200 and did not upgrade. The question marks in the table 105 represent the counterfactual outcome, which is not observed. For all these unseen counterfactual outcomes, pseudo-labels 130 which are imputed by an ML model and are used to augment the observational data 120. For all the unseen counterfactual outcomes, pseudo-labels, which are inserted in the table 106 (i.e., the question marks in table 105 are replaced with the counterfactual outcomes in table 106), are imputed by the ML model and are used to augment the observational data 120. The ML model is subsequently updated by training on both the imputed counterfactual data 130 and the factual data 135. This iterative training procedure continues until it converges to the randomized trial 125 outcomes.

In one embodiment, for the domain gap between the two distributions via an embedding, a randomized trial is explicitly simulated by imputing pseudo-labels 130 for the unobserved actions in the observational data 120. The optimization CST process is performed by iteratively updating the pseudo-labels 130 and the ML model that is trained on both the factual data in tale 105 and the counterfactual data.

In one embodiment, the CST process uses a self-training algorithm for counterfactual inference. In contrast to the conventional methods from domain adaption on counterfactual inference, CST processing is flexible and works with a wide range of ML models/algorithms, which is not limited to NNs. CST processing offers a theoretical motivation by providing an upper bound on the generalization error defined on a randomized trial 125 under the self-training objective. In other words, the counterfactual self-training processing or algorithm assists in minimizing the risk on the target domain. The bounds suggest generating pseudo-labels with random imputation, which is a methodological departure from traditional self-training algorithms that impute hard labels.

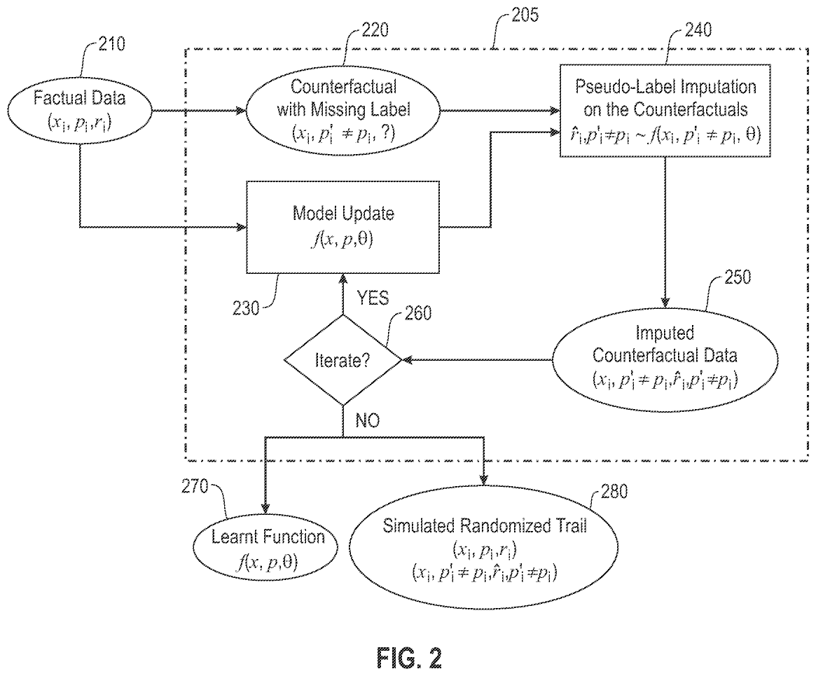

FIG. 2 illustrates a flow diagram for updating of an ML model by iterative training on both imputed counterfactual data and factual data, according to one embodiment. The symbol χ represents an abstract space and [symbol] (x) is a probability distribution on χ. Each sample x=x₁, . . . xₙ ∈ χⁿ is drawn independently from [symbol] (x). P is the discrete action space that a central agent can select for each sample, after which a reward r is revealed to the agent. In precision medicine, χ, P, and r may represent a patient cohort, feasible treatment for a disease, and an indicator of whether a patient survives after the treatment. In online marketing, χ, P, and r represent visitors, ads shown and click-through-rates. In pricing, χ, P, and r refer to customers, prices offered and an indicator in either a 1 (buy) or a 0 (no-buy).

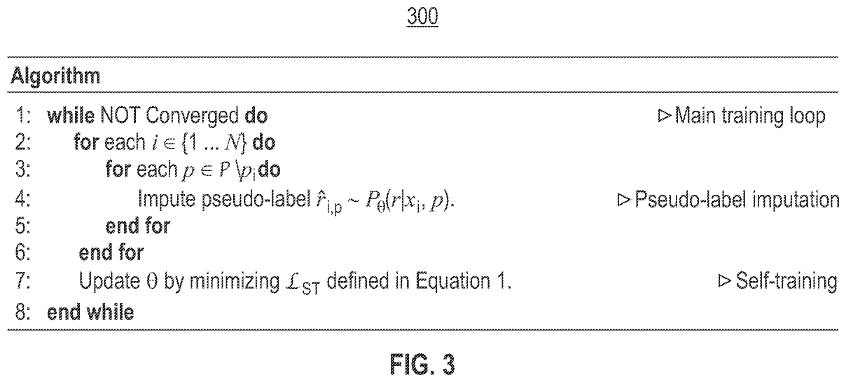

In one embodiment, the CST process 205 (see also algorithm 300, FIG. 3) may be viewed as an extension of the direct method via domain adaptation. Unlike conventional methods using representation learning, the CST process 205 is a self-training style process or algorithm that accounts for the bias inherent in the observational data.

Self-training has been used in unsupervised domain adaptation (UDA) and semi-supervised learning (SSL) and achieved success. The self-training algorithm works in an iterative fashion: first, after training a classifier ƒ(x, p) on a source dataset, pseudo-labels are created by the best guess of ƒ. Next, the model is trained on a target dataset, and the trained model is used to generate new pseudo-labels. This is illustrated in FIG. 1. To formulate the counterfactual learning problem as a domain adaptation problem, observational data is viewed as data sampled from a source distribution D_{S}= [symbol] (x)π(p|x). The target domain is a randomized trial on the same feature distribution to ensure a uniformly good approximation on all actions. The goal is to transfer observational data from the source domain to a simulated pseudorandomized trial via self-training. To accomplish this, first an initial classifier ƒ₀(x, p) is trained on observational data, then pseudo-labels are imputed on all unseen actions from the observation data with \hat{r}_{i,p}˜ƒ(x₁, p). The model is then updated by training with the following objective:

$${min}_{θ} {ℒ}_{ST} = \frac{1}{N \vert P \vert} ( {\underbrace{\begin{matrix}{\sum }_{i = 1}^{N} & l ( {f}_{θ} ( {x}_{i} , {p}_{i} ) , {r}_{i} )\end{matrix}}}_{{ℒ}_{src}} + {\sum }_{i = 1}^{N} {\sum }_{p ∈ P {\backslash}_{{p}_{i}}} l ( {f}_{θ} ( {x}_{i} , p ) , {\hat{r}}_{i , p} ) ) \qquad ( Eq . 1 )$$

In one embodiment, the first term [symbol] _{src} in Eq. 1 corresponds to the loss used in direct method, defined over the factual data alone. The second term refers to the loss defined over the imputed counterfactual data. In other words, in order to obtain a good model across all actions, the pseudo-population induced from imputation that represents a simulated randomized trial is utilized. The model is iteratively trained and pseudo-labels are imputed until the model converges.

FIG. 3 illustrates the CST algorithm 300 (in pseudo-code) for iteratively training an ML model including imputing pseudo-labels until convergence, according to one embodiment. Returning to FIG. 2, note that a key difference between the CST process 205 and traditional self-training (ST) methods for unsupervised domain adaptation is that: Pseudo-labels in traditional ST are generated from hard imputation while the CST process 205 provides that the pseudo-labels are sampled from a probability distribution as illustrated in the algorithm 300 on line 4. Not only does this randomized imputation have a theoretical motivation, it also demonstrates superior performance over hard imputation.

In one embodiment, in the flow diagram in FIG. 2 the factual data (xᵢ, pᵢ, r) 210 is the input to the counterfactual data (with missing label) (x₁, pᵢ′pᵢ,?) 220 and the model update (ƒ(x, p, θ)) 230. The output from the counterfactual data 220 and the model update 230 is input to the pseudo-label imputation on counterfactuals

$$( {\hat{r}}_{i , {p}_{i \neq {p}_{i}}^{′}} \sim f ( {x}_{i} , {p}_{i}^{′} \neq {p}_{i} , θ ) ) 240.$$

The output from the pseudo-label imputation on counterfactuals 240 is input to the imputed counterfactual data

$$( {x}_{i} , {p}_{i}^{′} \neq {p}_{i} , {\hat{r}}_{i , {p}_{i \neq {p}_{i}}^{′}} ) 250.$$

In block 260, as ling as the iteration is valid, the CST process 205 proceeds to the model update 230. Otherwise, the CST process 205 proceeds to the learnt function processing (ƒ(x, p, θ)) 270 and the simulated randomized trial processing

$$( ( {x}_{i} , {p}_{i} , {r}_{i} ) , ( {x}_{i} , {p}_{i}^{′} \neq {p}_{i} , {\hat{r}}_{i , {p}_{i \neq {p}_{i}}^{′}} ) ) 280.$$

In one embodiment, the objective is to augment observational data to a randomized trial such that the learnt model is able to perform better on all feasible actions. One focus is bounding the generalization error defined on a randomized trial. [symbol] is used to represent the distribution of a true randomized trial where the assignment policy is a uniform probability over P given context, and [symbol] is the distribution of pseudo-label generated by the current model output Pθ (r|x, p). [symbol] (ƒ) is defined as the risk of function ƒ with respect to a loss function l (·, ·) as [symbol] (ƒ)= [symbol] [l(ƒ(x, p), p)], and [symbol] (ƒ) as empirical risk on [symbol] . Assume that the classifier outputs a probability estimation P_{θ}(r|x, p) for a feature and action pair(x, p), and a random imputation \hat{r}˜P_{θ}(r|x, p) is used to generate outcomes for the unseen actions. Therefore, the theorem on the generalization bound is as follows: Assume

$${ℙ}_{θ} ( r \vert x , p ) \geq \frac{1}{{M}_{0} + 1} ,$$

where M₀>1 is constant, let

$$M = min \{ max ( \frac{ℙ}{{ℙ}_{θ}} - 1 ) , {M}_{0} \} , {f}^{*} = arg {min}_{f ∈ ℱ} {ℛ}_{𝒟} ( f ) , \hat{𝒟}$$

is the dataset generated by random imputation of current model output [symbol] _{θ}, and \hat{ƒ} minimizes the empirical risk on [symbol] For any loss function l(·, ·):

$${ℛ}_{𝒟} ( \hat{f} ) - {ℛ}_{𝒟} ( {f}^{*} ) \leq C ( \sqrt{\frac{V}{n}} + \sqrt{\frac{log ( \frac{1}{δ} )}{n}} ) + ( M + 1 ) {\hat{ℛ}}_{\hat{𝒟}} ( \hat{f} ) - {ℛ}_{𝒟} ( {f}^{*} ) \qquad ( Eq . 2 )$$

In one embodiment, by replacing M with M₀ and minimizing the right hand side of Eq. 2 over θ, Eq. 1 is recovered, which is the objective that is optimized in the training procedure. This complete optimization involves optimizing over θ and \hat{r}, and can be solved via classification expectation-maximization (CEM) and traditional self-training is an instance of CEM. These methods use a hard label as a classification step to impute the pseudo-labels but it is not clear how it relates to the risk that is of interest. To establish the theorem on the generalization bound, a random imputation of labels based on the probability output of the classifier is required to upper bound the risk under a true randomized trial using this objective. Therefore, a random sampling is used to generate pseudo-labels in the algorithm 300 (FIG. 3), which is more robust than hard labels. It should be noted that this bound is relatively loose when [symbol] very different from [symbol] _{θ}, thus we only use it as a motivation of our proposed algorithm. Since in the source domain, P=P_, it is possible to get a tighter upper bound. Since cross-validation is biased in the counterfactual learning due to the logging policy, hyperparameters are avoided.

In one example embodiment, synthetic datasets for a pricing are constructed and three real datasets are used to show the efficacy of the CST algorithm 300. In one example embodiment, a three layer neural network with 128 nodes is used as the model and binary entropy loss is used as the loss function. Early stopping is avoided and each method is trained until convergence to ensure a fair comparison. The following baselines are considered: 1) the direct method (DM): this baseline directly trains a model on observational data; 2) Hilbert-Schmidt Independence Criteria (HSIC): the last layer is used as an embedding and HSIC is calculated between the embedding and the actions. The training objective is binary cross entropy loss+λ HSIC, where λ is the hyperparameter that is chosen from a grid search over [0:01; 0:1; 1; 10; 100]; 3) BanditNet is a counterfactual risk minimization (CRM) based method developed for deep nets. For the baseline required in BanditNet, the reward is we normalized and the hyperparameter is chosen using a grid search over [0; 0:2; 0:4; 0:6; 0:8] and cross validation. Since BanditNet is designed for reward maximization, evaluation of the accuracy (i.e., hamming loss) is not appropriate under the problem. In each example embodiment, BanditNet is only evaluated in the reward comparison. In other example embodiments, two versions of CST are employed, one with random imputation (CST-RI) and one with deterministic pseudo-labels commonly used in self-training by an argmax operation \hat{r}=argmaxᵣ, ƒ(r|x, p), which is referred to as CST-AI. Unlike CST, HSIC and BanditNet require a hyperparameter as an input to the algorithms. In one example embodiment, a 5-fold cross-validation and grid search are used to select the hyperparameter. The skyline method finds a Pareto optimal subset of points in a multi-dimensional dataset. The example embodiments are conducted with five repetitions. The mean and standard error are reported for each metric. Several synthetic datasets and three counterfactual learning datasets converted from multi-label classification tasks are used for evaluation. In all example embodiments, the CST algorithm 300 shows competitive or superior performance against all the baselines. Moreover, the CST algorithm 300 is easy to optimize with a much faster training time than other baselines.

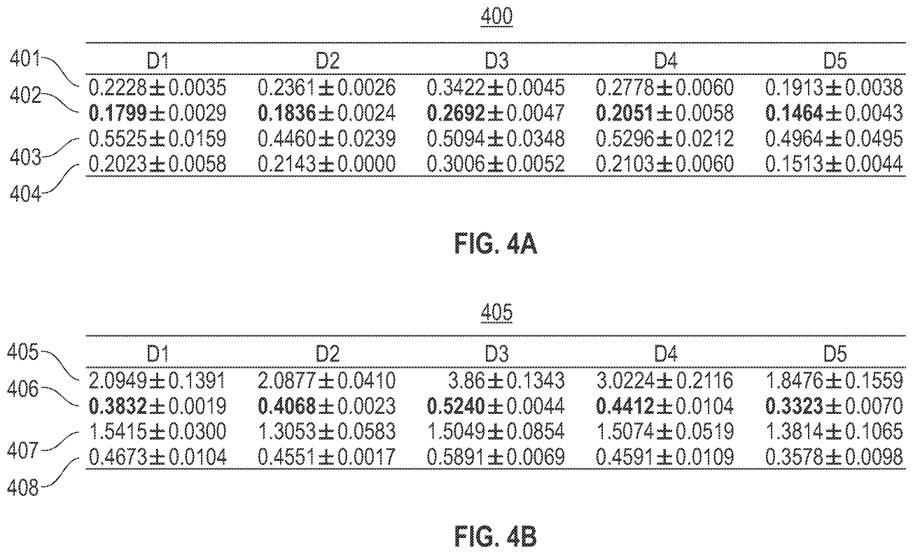

FIG. 4A illustrates a table 400 showing Hamming loss on synthetic datasets (DM 401, CST-RI 402, CST-AI 403 and HSIC 404) for a CST process (e.g., CST process 205, FIG. 2, CST algorithm 300, FIG. 3), according to one embodiment. In one example embodiment, a pricing example is undertaken. Let U(·, ·) be a uniform distribution. Assume customer features are a 50-dimensional vector X drawn from U(0, 1)⁵⁰ and there are ten (10) price options from $1 to $10. The logging policy is set as

$$π ( p = i \vert x ) = \frac{{x}_{i}}{{\sum }_{i = 1}^{10} {x}_{i}} .$$

Five types of demand functions (D1, D2, D3, D4 and D5) are simulated. For each demand function 1000 samples are generated and the Hamming loss is reported, which relies on the hard labels generated by the CST process. Among all datasets, the CST-RI 402 has the best performance in terms of Hamming loss.

FIG. 4B illustrates a table 405 showing a multi-label soft-margin loss on synthetic datasets (DM 405, CST-RI 406, CST-AI 407 and HSIC 408) for a CST process, according to one embodiment. Among all datasets, the CST-RI 406 has the best performance in terms of soft-margin loss.

FIG. 4C illustrates a table 410 showing a total reward on a synthetic dataset (DM 409, CST-RI 410, CST-AI 411, HSIC 412, BanditNet 413 and Skyline 414) for the CST process, according to one embodiment. As a pricing application, the revenue generated on the test set is evaluated by solving the revenue maximization problem:

$${p}_{i} = {arg max}_{p} ℙ ( r = 1 \vert {x}_{i} , p ) \cdot p \qquad Eq . 3$$

For each dataset, the test set has 5000 samples from the corresponding demand distribution. The results are shown in table 410. HSIC 412 outperforms DM 409 baseline by a significant margin and comes as a close second to CST-RI 410. In four out of five demand functions (with the exception of D1), CST-RI 410 achieves a comparable or superior performance on reward as shown in table 410.

In one embodiment, while CST-RI 410 results in the best demand model in terms of the losses, it does not guarantee the highest revenue in all cases. This is because the downstream optimization task is independent from demand estimation. Nevertheless, CST-RI 410 significantly outperforms BanditNet 413 (and skyline 414), which is designed for reward maximization due to unknown logging policy. CST-AI 411 performs worse than DM 410, which is a naive baseline, demonstrating the importance of random imputation in the CST process.

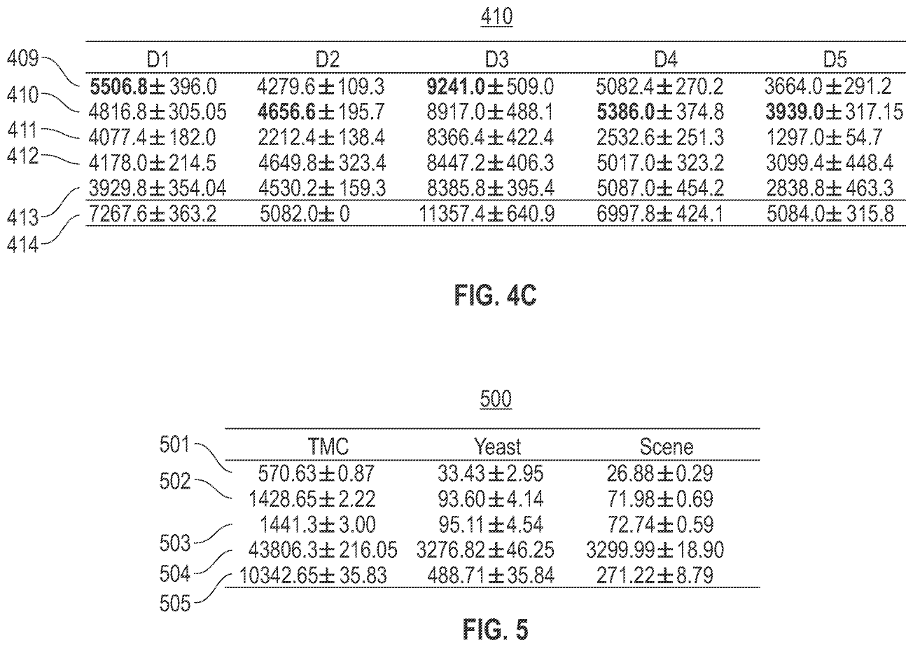

FIG. 5 illustrates average running time results for the CST process using three datasets (TMC, Yeast and Scene), according to one embodiment. The three multi-label datasets are from the LIBSVM repository, which are used for semantic scene, text and gene classification. The supervised learning datasets are converted to bandit feedback by creating a logging policy using 5% of the data. More specifically, each feature x has a label y ∈ {0, 1}^{p} where p is the number of labels. After the logging policy selects a label (action) i, a reward yᵢ is revealed as bandit feedback (x; i, yᵢ), i.e., for each data point, if the policy selects one of the correct labels of that data point, it gets a reward of 1, and 0 otherwise. By doing so, the full knowledge of counterfactual outcomes for evaluation is obtained. Reward results are included in table 500 for DM 501, CST-RI 502, CST-AI 503, HSIC 504 and BandiNet 505. CST-RI 502 generally achieves comparable or superior performance against all baselines in all three datasets. Since it is assumed that the logging policy is not known, BanditNet 505 performs poorly in datasets such as Scene. HSIC 504 has a comparable performance with CST-RI 502 on TMC and Yeast, but performs poorly on Scene. It is suspected that this result is due to the bias introduced in cross-validation, which in turn results in a sub-optimal hyperparameter selection. Overall, CST-RI 502 shows the most robust performance across all three metrics being studied.

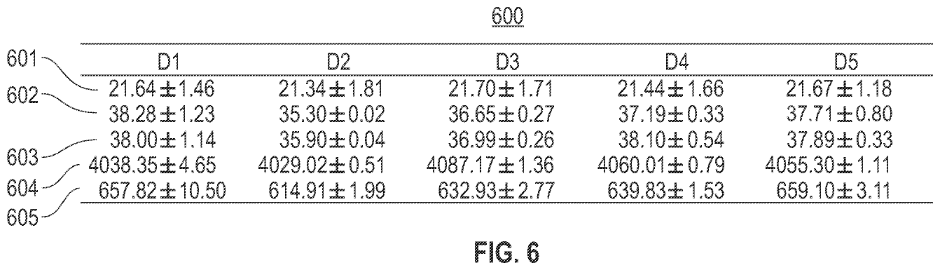

FIG. 6 illustrates average running time results for synthetic datasets for a CST process, according to an embodiment. In table 600, the average running time for one repetition for each experiment under same number of epochs is shown for DM 601, CST-RI 602, CST-AI 603, HSIC 604 and BandiNet 605. Unsurprisingly, DM 601 is the fastest algorithm. While the CST process (CST-RI 602 and CST-AI 603) is almost twice as slow as DM 601, it is still relatively fast compared to the other baselines. BanditNet 605 is relatively slow due to the cross validation selection. Note that the time efficiency of HSIC 604 is bottlenecked by its high computational complexity. HSIC 604 is approximately 30 to 100 times slower than the CST process across all datasets. Since the CST process offers a competitive performance against HSIC 604 with a much faster running time, it is potentially more suitable for large-scale applications.

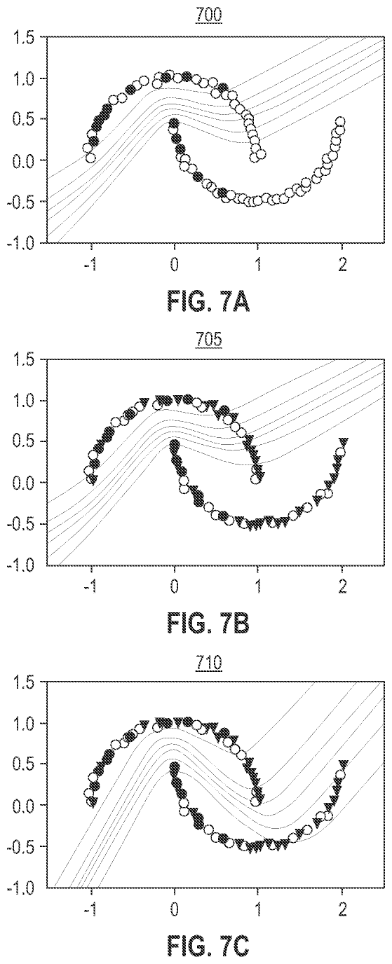

FIG. 7A illustrates a graph 700 for the CST process with a DM on factual data alone, according to an embodiment. The solid circles represent factual data, the translucent circles represent unlabeled counterfactuals and the triangles represent imputed data. FIG. 7B illustrates a graph 705 showing results after a first imputation with a CST process, according to an embodiment. FIG. 7C illustrates a graph 710 showing results upon convergence with the CST process, according to an embodiment. Under some technical conditions, it can be shown that the CST process converges as compared to the DM as the CST process better utilizes the underlying data structure and refines the decision boundary through extrapolation between actions. In domain adaption, when a source domain and target domain are too similar or unrelated, self-training algorithms may not work. In the counterfactual setting, such domain gap is characterized by the difference between the historical logging policy and a randomized trial.

In one embodiment, the CST process may be applied to settings with discrete actions (including continuous actions that can be discretized) and discrete outcomes to help de-bias observational data and train a more robust and consistent estimator. In personalized/precision medicine, the CST process may estimate the impact of the treatment given patient features. In advertisement targeting, the CST process may estimate the response of different advertisements given user features. In customer relationship management applications such as dealing with customer complaints, the CST process may determine the response/satisfactions of different interventions (e.g., generic email apology, personal phone call, cash or cash equivalent compensation, etc.).

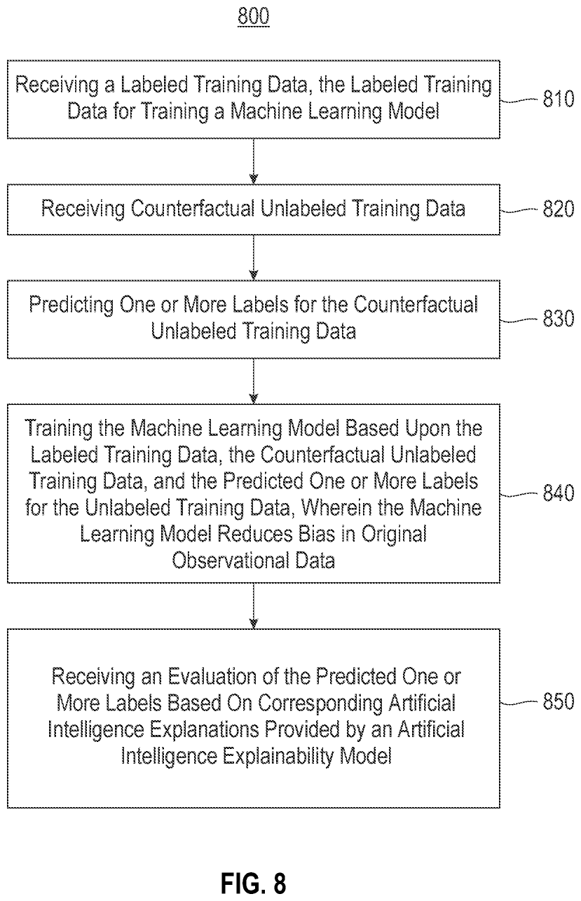

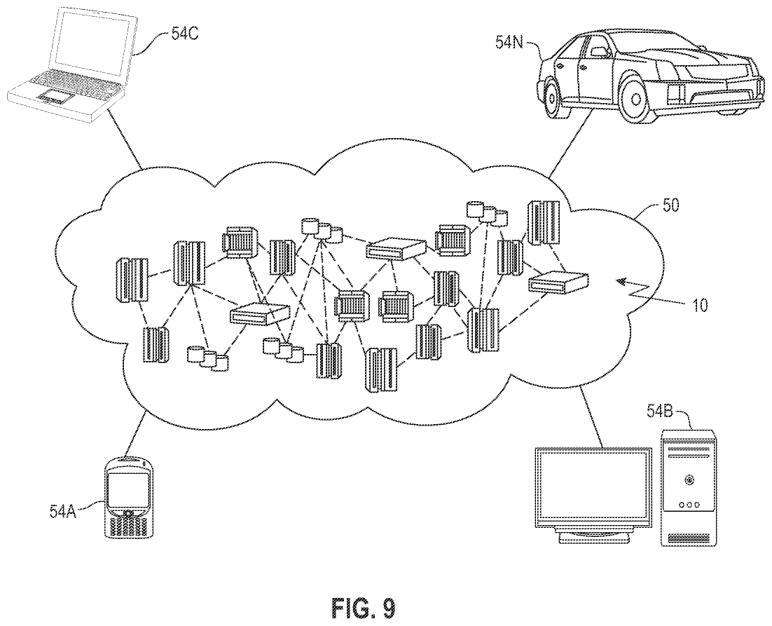

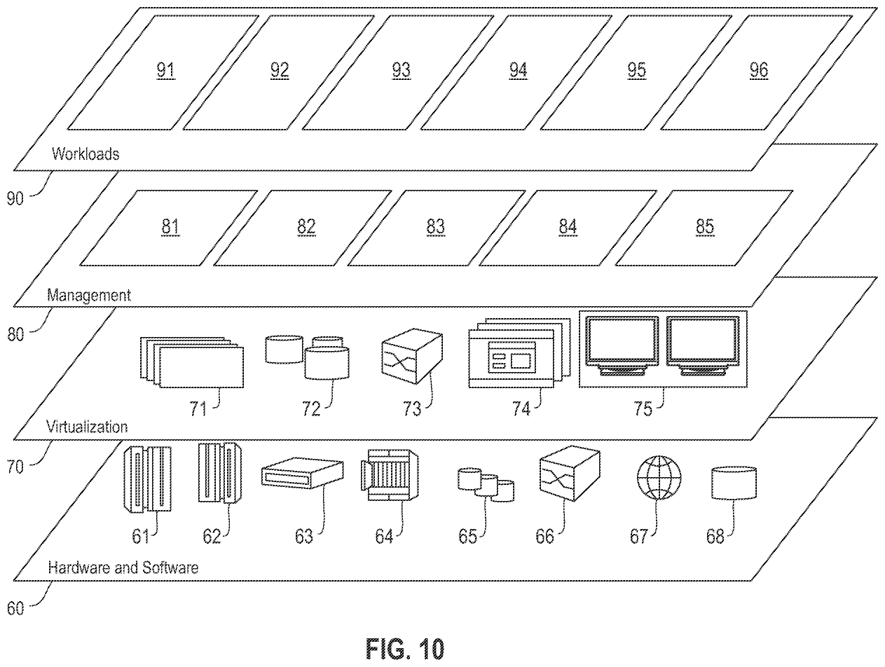

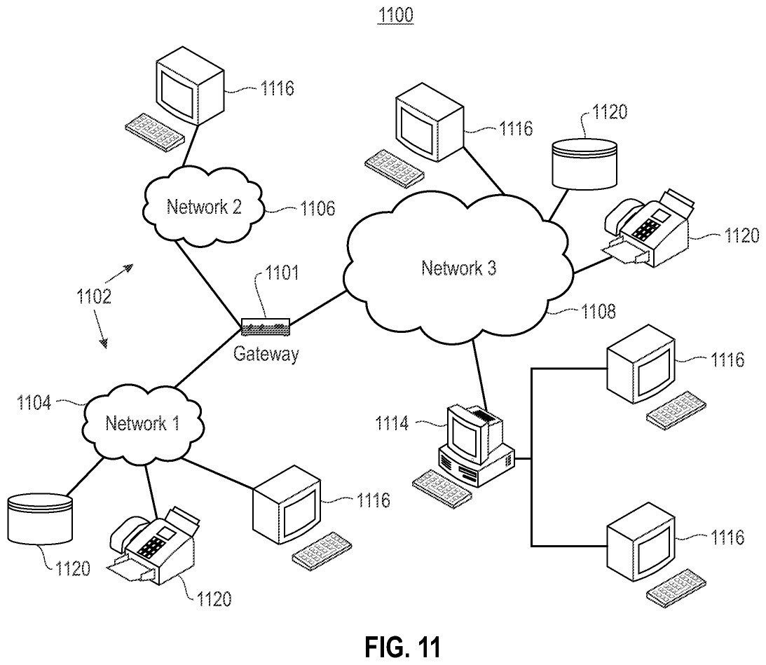

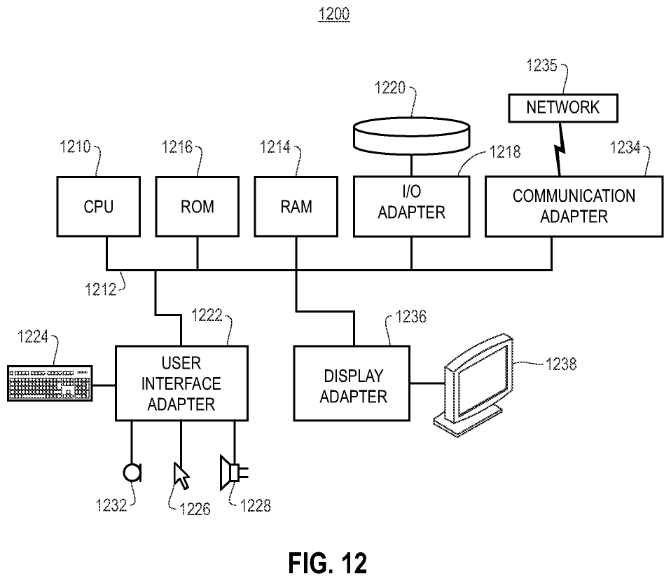

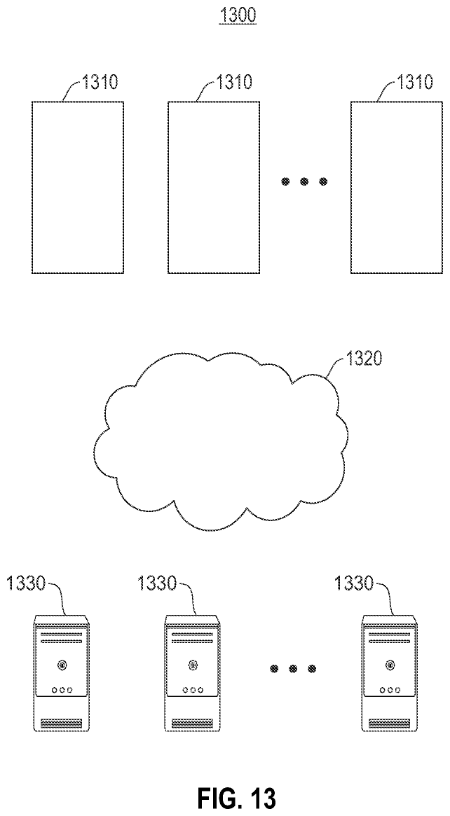

FIG. 8 shows a CST process 800 for reducing bias in observational data by simulating a randomized control trial, according to an embodiment. In one embodiment, in block 810, process 800 receives, by a computing device (from computing node 10, FIG. 9, hardware and software layer 60, FIG. 10, processing system 1100, FIG. 11, system 1200, FIG. 12, system 1300, FIG. 13, etc.) a labeled training data, the labeled training data for training a machine learning model (e.g., FIG. 2). In block 820, process 800 further provides receiving, by the computing device, counterfactual unlabeled training data. In block 830, process 800 further provides predicting, by the computing device, one or more labels for the counterfactual unlabeled training data (e.g., CST process 205, FIG. 2, CST algorithm 300, FIG. 3). In block 840, process 800 additionally provides training, by the computing device, the machine learning model based upon the labeled training data, the counterfactual unlabeled training data, and the predicted one or more labels for the unlabeled training data. The machine learning model reduces bias in original observational data. In block 850, process 800 further provides receiving an evaluation, by the computing device, of the predicted one or more labels based on corresponding AI explanations provided by an AI explainability model. AI Explainability models refer generally to AI methods, techniques, and algorithms that support the ability to explain or interpret the prediction of an ML model or its inner-workings. Sometimes, the term explainability is more specifically used when the model's prediction can be explained in human terms, while the term interpretability can be used when a relationship between a cause and an effect can be observed in the system and its internal components. In one or more embodiments, the evaluation is a user evaluation that is electronically received by the computing device.

In one embodiment, process 800 may further include the feature that the machine learning model simulates a randomized control trial.

In one embodiment, process 800 may additionally include the feature the simulated randomized control trial data mitigates the bias present in the original observational data due to historical policy.

In one embodiment, process 800 may still additionally include the feature that the machine learning model is applied to settings with discrete actions and discrete outcomes.

In one embodiment, process 800 may further include the feature that the machine learning model imputes labels on the counterfactual unlabeled training data.

In one embodiment, process 800 may still further include the feature that the machine learning model is iteratively updated on the imputed labels and factual data, and re-imputes labels until convergence.

In one embodiment, process 800 may further include the feature that an initial classifier is trained on the original observational data.

Most of the work on counterfactual inference can be divided into two categories: CRM and DM. CRM, also known as off-policy learning or batch learning from bandit feedback, typically utilizes inverse propensity weighting (IPW) to account for the bias in the data. In contrast to DM, CRM-based methods use the final reward as objective to learn a policy π(p|x) that maximizes [symbol] [r|p]. The limitations of CRM-based methods include [symbol] that they tend to struggle with medium to large action spaces in practice. Moreover, the CRM-based methods generally require a known and stochastic logging policy, along with full support on the action space. When either one of the requirements is violated, it has been shown that DM often demonstrates a more robust performance.

In one or more embodiments, a system and method are provided for the CST process to account for the bias in the observational data by explicitly simulating a random trial over the same feature distribution. The CST process iteratively fine-tunes a ML model and imputes pseudo-labels of the unobserved counterfactual data in a self-training fashion. Compared to conventional methods, the CST process offers flexibility on the choice of ML models, which are not just limited to neural networks. The CST process is also simple and fast to optimize, which results in savings in hardware requirements. With the augmented data, which is in the form of a simulated random trial, one can produce more reliable estimators that generally lead to better downstream decision making. The trained model and the augmented data may be input to AI Explainability that provides explanations to the predictions. One may potentially use the quality of those explanations as a determination criteria to help evaluate the performance of the trained model. AI explanations are provided by an AI Explainability model.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

Referring now to FIG. 9, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

Referring now to FIG. 10, a set of functional abstraction layers provided by the cloud computing environment 50 (FIG. 9) is shown. It should be understood in advance that the components, layers, and functions shown in FIG. 10 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for a CST processing 96 for reducing bias in observational data by simulating a randomized control trial (see, e.g., process 800, FIG. 8, system 10, FIG. 9, system 1100, FIG. 11, system 1200, FIG. 12, system 1300, FIG. 13, etc.). As mentioned above, all of the foregoing examples described with respect to FIG. 10 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

FIG. 11 is a network architecture of a system 1100 for CST processing for reducing bias in observational data by simulating a randomized control trial, according to an embodiment. As shown in FIG. 11, a plurality of remote networks 1102 are provided, including a first remote network 1104 and a second remote network 1106. A gateway 1101 may be coupled between the remote networks 1102 and a proximate network 1108. In the context of the present network architecture 1100, the networks 1104, 1106 may each take any form including, but not limited to, a LAN, a WAN, such as the Internet, public switched telephone network (PSTN), internal telephone network, etc.

In use, the gateway 1101 serves as an entrance point from the remote networks 1102 to the proximate network 1108. As such, the gateway 1101 may function as a router, which is capable of directing a given packet of data that arrives at the gateway 1101, and a switch, which furnishes the actual path in and out of the gateway 1101 for a given packet.

Further included is at least one data server 1114 coupled to the proximate network 1108, which is accessible from the remote networks 1102 via the gateway 1101. It should be noted that the data server(s) 1114 may include any type of computing device/groupware. Coupled to each data server 1114 is a plurality of user devices 1116. Such user devices 1116 may include a desktop computer, laptop computer, handheld computer, printer, and/or any other type of logic-containing device. It should be noted that a user device 1116 may also be directly coupled to any of the networks in some embodiments.

A peripheral 1120 or series of peripherals 1120, e.g., facsimile machines, printers, scanners, hard disk drives, networked and/or local storage units or systems, etc., may be coupled to one or more of the networks 1104, 1106, 1108. It should be noted that databases and/or additional components may be utilized with, or integrated into, any type of network element coupled to the networks 1104, 1106, 1108. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICRO SOFT® WINDOWS® system that emulates an IBM® z/OS environment, etc. This virtualization and/or emulation may be implemented through the use of VMWARE® software in some embodiments.

FIG. 12 shows a representative hardware system 1200 environment associated with a user device 1116 and/or server 1114 of FIG. 11, in accordance with one embodiment. In one example, a hardware configuration includes a workstation having a central processing unit 1210, such as a microprocessor, and a number of other units interconnected via a system bus 1212. The workstation shown in FIG. 12 may include a Random Access Memory (RAM) 1214, Read Only Memory (ROM) 1216, an I/O adapter 1218 for connecting peripheral devices, such as disk storage units 1220 to the bus 1212, a user interface adapter 1222 for connecting a keyboard 1224, a mouse 1226, a speaker 1228, a microphone 1232, and/or other user interface devices, such as a touch screen, a digital camera (not shown), etc., to the bus 1212, communication adapter 1234 for connecting the workstation to a communication network 1235 (e.g., a data processing network) and a display adapter 1236 for connecting the bus 1212 to a display device 1238.

In one example, the workstation may have resident thereon an operating system, such as the MICROSOFT® WINDOWS® Operating System (OS), a MAC OS®, a UNIX® OS, etc. In one embodiment, the system 1200 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 13 is a block diagram illustrating a distributed system 1300 for CST processing for reducing bias in observational data by simulating a randomized control trial, according to one embodiment. In one embodiment, the system 1300 includes client devices 1310 (e.g., mobile devices, smart devices, computing systems, etc.), a cloud or resource sharing environment 1320 (e.g., a public cloud computing environment, a private cloud computing environment, a data center, etc.), and servers 1330. In one embodiment, the client devices 1310 are provided with cloud services from the servers 1330 through the cloud or resource sharing environment 1320.

One or more embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to self-train a machine learning model with an incomplete dataset including original observational data, the method comprising:
receiving, by the computing device, a labeled training data, the labeled training data for training a machine learning model;
receiving, by the computing device, counterfactual unlabeled training data;
predicting, by the computing device, one or more labels for the counterfactual unlabeled training data;
training, by the computing device, the machine learning model based upon the labeled training data, the counterfactual unlabeled training data, and the predicted one or more labels for the unlabeled training data, wherein the machine learning model reduces bias in original observational data; and
receiving, by the computing device, an evaluation of the predicted one or more labels based on corresponding artificial intelligence explanations provided by an artificial intelligence explainability model.

2. The method of claim 1, wherein the machine learning model simulates a randomized control trial.

3. The method of claim 2, wherein the simulated randomized control trial data mitigates the bias present in the original observational data due to historical policy.

4. The method of claim 1, wherein the machine learning model is applied to settings with discrete actions and discrete outcomes.

5. The method of claim 1, wherein the machine learning model imputes labels on the counterfactual unlabeled training data.

6. The method of claim 5, wherein the machine learning model is iteratively updated on the imputed labels and factual data, and re-imputes labels until convergence.

7. The method of claim 1, wherein an initial classifier is trained on the original observational data.

8. A computer program product for self-training a machine learning model with an incomplete dataset including original observational data, the computer program product comprising one or more computer readable storage medium having program instructions embodied therewith, the program instructions executable by a processor to cause the processor to:
receive, by the processor, a labeled training data, the labeled training data for training a machine learning model;
receive, by the processor, counterfactual unlabeled training data;
predict, by the processor, one or more labels for the counterfactual unlabeled training data;
train, by the processor, the machine learning model based upon the labeled training data, the counterfactual unlabeled training data, and the predicted one or more labels for the unlabeled training data, wherein the machine learning model reduces bias in original observational data; and
receive, by the processor, an evaluation of the predicted one or more labels based on corresponding artificial intelligence explanations provided by an artificial intelligence explainability model.

9. The computer program product of claim 8, wherein the machine learning model simulates a randomized control trial.

10. The computer program product of claim 9, wherein the simulated randomized control trial data mitigates the bias present in the original observational data due to historical policy.

11. The computer program product of claim 8, wherein the machine learning model is applied to settings with discrete actions and discrete outcomes.

12. The computer program product of claim 8, wherein the machine learning model imputes labels on the counterfactual unlabeled training data.

13. The computer program product of claim 12, wherein the machine learning model is iteratively updated on the imputed labels and factual data, and re-imputes labels until convergence.

14. The computer program product of claim 8, wherein an initial classifier is trained on the original observational data.

15. An apparatus comprising:
a memory configured to store instructions; and
a processor configured to execute the instructions to:
receive a labeled training data, the labeled training data for training a machine learning model;
receive counterfactual unlabeled training data;
predict one or more labels for the counterfactual unlabeled training data;
train the machine learning model based upon the labeled training data, the counterfactual unlabeled training data, and the predicted one or more labels for the unlabeled training data, wherein the machine learning model reduces bias in original observational data; and
receive an evaluation of the predicted one or more labels based on corresponding artificial intelligence explanations provided by an artificial intelligence explainability model.

16. The apparatus of claim 15, wherein the machine learning model simulates a randomized control trial.

17. The apparatus of claim 16, wherein the simulated randomized control trial data mitigates the bias present in the original observational data due to historical policy.

18. The apparatus of claim 15, wherein the machine learning model is applied to settings with discrete actions and discrete outcomes.

19. The apparatus of claim 15, wherein the machine learning model imputes labels on the counterfactual unlabeled training data.

20. The apparatus of claim 19, wherein the machine learning model is iteratively updated on the imputed labels and factual data, and re-imputes labels until convergence, and an initial classifier is trained on the original observational data.
